(19) United States
(12) Patent Application Publication
(10) Pub. No.: US 2023/0143168 A1
(43) Pub. Date: May 11, 2023

(54) Direct Coupling Device for Generating Hydrogen from Concentrated Sunlight

(71) Applicant: FUSION WELCOME-FUEL, S.A., Almargem do Bispo (PT)

(72) Inventor: Jaime Domingos FERREIRA SILVA, Lisboa (PT)

(73) Assignee: FUSION FUEL PORTUGAL S.A., Almargem do Bispo (PT)

(21) Appl. No.: 17/910,758

(22) PCT Filed: Aug. 3, 2020
(86) PCT No.: PCT/IB2020/057331

§ 371 Date: Sep. 9, 2022

(30) Foreign Application Priority Data
Mar. 10, 2020 (PT) 116152 Y

(51) Int. Cl. C25B 1/04; C25B 9/23; C25B 9/65; C25B 11/032; H02S 40/36; H02S 40/22; H02S 40/44; C25B 1/55

(52) U.S. Cl. CPC C25B 1/04; C25B 9/23; C25B 9/65; C25B 11/032; H02S 40/36; H02S 40/22; H02S 40/44; C25B 1/55

(57) ABSTRACT

This invention is a direct coupling device (31) to generate hydrogen from concentrated sunlight comprised of a solar concentrator (32) and a water electrolyser (33) where the solar concentrator (32) is comprised of an optical concentration element (15), adjacent to a number of photovoltaic cells (14) coupled to a heat exchanger (13) and the water electrolyser (33) comprised of a proton exchange membrane (2) in which the membrane is comprised of a number of individualized anode zones (6) and cathodic zones (12) coated with a catalyst, a number of cathode single-polar plates (3) and a number of anode single-polar plates (5), a number of regeneration electrodes (1), a number of floating flow guide plates (7), a number of elastic compression elements (8) and a casing consisting of an upper (9) and a lower (10) part.

The invention is a device to collect and concentrate sunlight, convert concentrated sunlight into electrical and thermal energy and use this energy to power a single proton membrane water electrolyser with several individualized anodic and cathodic catalyst coated zones, with direct coupling to generate hydrogen gas with better performance and service life.

### STATE OF THE ART

The Chinese patent application CN 105483745 concerns a concentrated solar energy module and an electrolysis hydrogen production module, however, the application we intend to protect differs substantially from the Chinese patent application in that it is a single direct coupling device, which produces hydrogen from sunlight and water and only uses liquid water avoiding the use of water vapour.

### DETAILED DESCRIPTION OF THE INVENTION

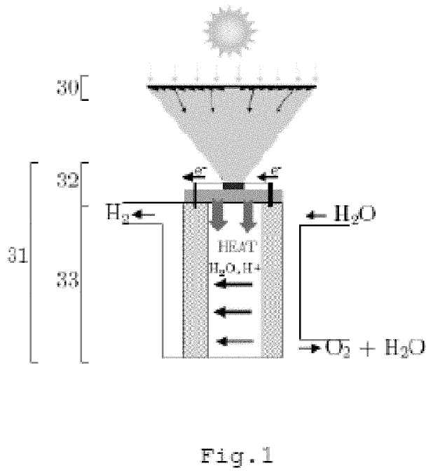

FIG. 1 illustrates the operating concept of the device, showing that sunlight is collected and concentrated at a factor of 200× or more using a Fresnel lens 30, for the direct coupling device 31, comprised of a solar concentrator 32 and a water electrolyser 33.

The sunlight is further concentrated at a factor of 1× or more using the Solar Concentrator 32, which converts the concentrated sunlight into electrical and thermal energy, and which also transfers the energy to the water electrolyser 33, where thermal energy raises the temperature of the water circulating through the water electrolyser 33 and where electrical energy feeds the electrochemical electrolysis of the water, resulting in the generation of hydrogen and oxygen.

The direct coupling device 31 comprises a proton exchange membrane 2, such as Nafion® or another ionomer, copolymer or polymer mixture, with several anodic individualized zones (6) coated with catalyst on one side of the membrane suitable to facilitate the oxidation of water, and several cathodic individualized zones (12) coated with catalyst on the opposite side suitable to facilitate/allow the reduction of protons to hydrogen gas, several cathode single-polar plates (UPP) 3 and several anode UPPs 5, each with a pair of cathode and anode UPPs enclosing the proton exchange membrane 2 and adjacent to the individualized areas coated with catalyst 12 and 6 on the cathode side and the anode side respectively.

The direct coupling device 31 also comprises several regeneration electrodes 1, enclosing the proton exchange membrane 2 and arranged towards the edge of the individualized zones coated with catalyst 6 and 12, so that they are adjacent to the coated zones on both sides of the proton exchange membrane 2, several floating flow guide plates 7 on both sides, enclosing the UPPs 5 and 3 and the proton exchange membrane 2 between them, several elastic compression elements 8 on both sides, enclosing the flow guide plates 7, the UPPs 5 and 3 and the proton exchange membrane 2 between them.

The device also has a casing consisting of an upper part 9 and a lower part 10, sealed together and enclosing the elastic compression elements 8, the floating flow guide plates 7, the UPPs 5 and 3, the regeneration electrodes 1 and the proton exchange membrane 2 between them, a source of electrical and thermal energy and the concentrator converter 32 connected to the top 9 of the casing.

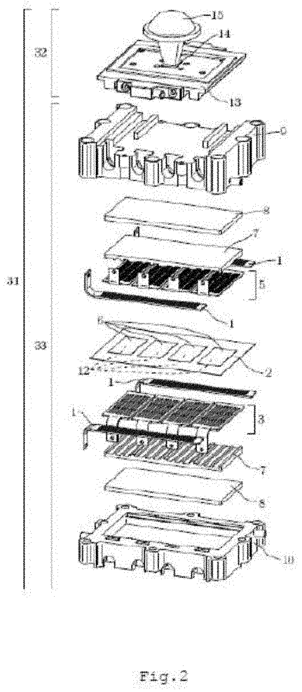

As illustrated in FIG. 2, the concentrator converter 32 has an optical concentration element 15 glued to a photovoltaic cell 14 coupled with a heat exchanger 13. The optical concentration element 15 is made of glass with suitable optical composition, such as borosilicate glass which, by refraction and/or total internal reflection, redirects and further concentrates the sunlight falling on its upper surface in a multiple junction type photovoltaic cell 14, such as a triple-junction structure of GaInP/GaInAs/Ge or similar high-efficiency solar cell. The solar energy that is not directly converted into electrical energy by photovoltaic cell 14 is absorbed as thermal energy by the heat exchanger 13, made of an aluminium, copper or copper alloy, and which has several closed channels where water can circulate and be heated by the thermal energy.

The casing, which consists of an upper part 9 and a lower part 10, provides mechanical support for the other parts of the water electrolyser 33. The casing is typically made of a thermoplastic or thermoset polymer, with or without reinforcing additives or other similar material with appropriate electrical insulation properties and chemical and mechanical resistance.

The elastic compression element 8 can be made of, among other materials, a polymer material, a metal, an elastomer foam, or other materials with a suitable elasticity module, typically in the shape of a solid rectangular block, but which may also be hollow and may also include round or rectangular holes.

The floating flow guide plates 7 are typically made of a polymer, or polymer mixture, or any other suitable rigid material that is not electrically conductive, including metal alloys coated with electrically insulating layers. There are several open channels on their main surface facing the anode 5 or cathode 3 UPPs respectively. When assembled, and by the action of the elastic compression elements 8, the floating flow guide plates 7 press against the main cooperating surfaces of the single-polar plates 5 and 3 to allow the inlet of water and outlet of water and oxygen, and the outlet water and hydrogen respectively. The elastic compression elements 8 also provide the necessary contact force to allow close contact between the UPPs 5 and 3 and their individualized zones coated with catalyst 6 and 12 so that the electrical contact resistance between them can be kept to a minimum, thus lowering the operating voltage of the electrolysis reaction.

Anode 5 UPPs are typically made of titanium or a titanium alloy, with several round or rectangular holes, arranged on their main surface, serving as a combination of a gas diffusion layer and a current collector. Anode 5 UPPs are typically coated with a thin film of platinum or a platinum alloy.

Cathode 3 UPPs are typically made of a stainless-steel alloy with several round or rectangular holes, arranged on their main surface, serving as a combination of a gas diffusion layer and a current collector, usually with a thin coating of gold.

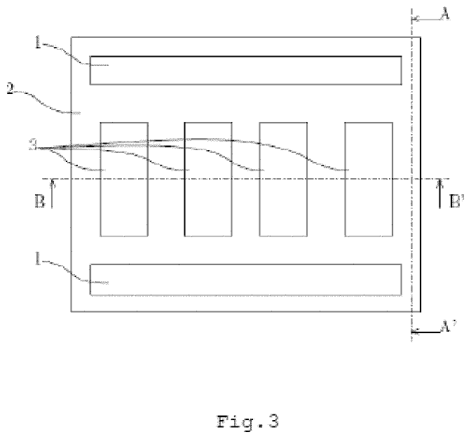

Regarding FIG. 3, it can be seen that the cathode UPPs 3 are arranged side by side against the proton exchange membrane 2, with some space separating them from each other and the regeneration electrodes 1, so that they are all physically separated from each other.

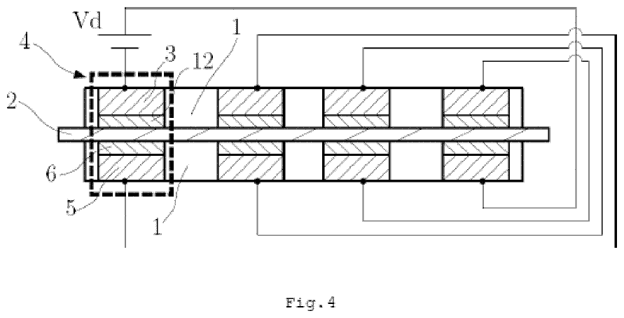

FIG. 4 illustrates the electrical circuitry that conducts the electrolysis reaction. A cathode UPP (3) in contact with an individualized zone coated with a catalyst (12) of the proton exchange membrane 2 and facing an anode UPP 5 in contact with an individualized zone coated with catalyst 6 constitutes an electrochemical cell (4), the cathode UPP 3 is negatively polarized and the anode UPP 5 is positively polarized. Each electrochemical cell (4) is connected in series to the next, as illustrated in the circuit diagram, and all share the same proton exchange membrane 2.

The Vd voltage needed to ensure the electrolysis of the water is provided by the concentrator converter 32, illustrated in FIG. 2.

The direct coupling device 31 should use very pure water free of ionic contaminants. The quality of deionized water is generally measured by its resistivity, which should be as high as possible (up to >18 MΩ cm) to avoid contaminating the proton exchange membrane with unwanted cations during operation and that accumulate over time impairing the electrolyser's performance and lifespan. However, in practice, and for economic reasons, it is desirable to use less pure water with resistivity >4 MΩ cm. To allow the use of less pure water, it is necessary to greatly reduce the accumulation of ionic contaminants in the proton exchange membrane and therefore the water electrolyser 33, as illustrated in FIG. 2, has several regeneration electrodes 1, enclosing the proton exchange membrane 2.

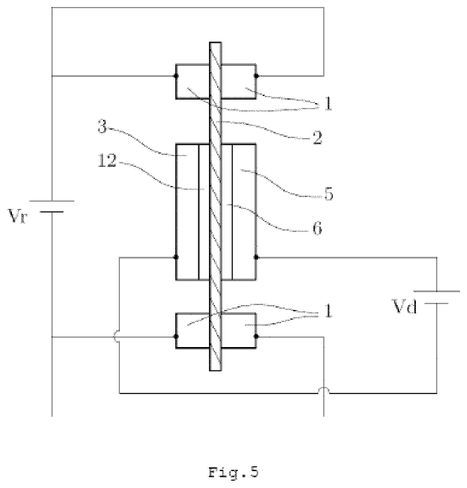

Concerning FIG. 5, when the device is not in operation, for example at night or if it is overcast, the control voltage for electrolysis is V =0V. Under these conditions, an external circuit connected to regeneration electrodes 1 provides a Vr voltage of about 2 to 25 V, thereby establishing an electrical field that causes the cations accumulated on the proton exchange membrane 2 to move towards the enclosed zone between the negatively charged regeneration electrodes and out of the enclosed zones between the UPPs, thereby removing contamination in the active zones of the electrolyser and significantly extending the life of the proton exchange membrane 2.

This invention also has a method for generating hydrogen by the direct coupling device 31 with the following steps:
establish the water supply circuit for electrolysis, where the flow enters the heat exchanger 13, exiting towards the water inlet from the top of the casing 9, through which it enters, to be distributed on the floating flow guide plates 7 to bathe the anode UPPs 5, the regeneration electrodes 1, the catalyst coated areas 6 and the proton exchange membrane 2;
establish the hydrogen and water sampling circuit, in which a flow of hydrogen and water is led out of the cavity at the bottom of the liner 10 towards a suitable container;
point the direct coupling device 31 towards the sun to capture the electrical and thermal energy needed to sustain the electrolysis of the water;
close the electrical circuit to polarize the UPP 3 and 5 with the operating voltage Vd supplied by the photovoltaic cell 14, initiating the electrolysis of the water, which was heated during its passage through the heat exchanger 13;
keep the assembly pointed at the sun as mentioned in step (3) for as long as the hydrogen generation is desired;

When no more hydrogen is required, stop the production by no longer pointing the assembly at the sun as referred to in step (3) and opening the electric circuit referred to in step (4).

Carry out the regeneration of the active zones of the proton exchange membrane 2 by closing the external circuit connecting the source of a voltage Vr to the regeneration electrodes 1 periodically at appropriate intervals and for an appropriate time when the production of hydrogen is interrupted (or it is not possible to produce directly from solar energy, especially at night or when it is overcast).

### Figure Key

1—Regeneration electrodes
2—Proton exchange membrane
3—Single-polar cathode plate (UPP)
4—Electrochemical cell
5—Single-polar anode plate (UPP)
6—Individualized anodic zone coated with a catalyst
7—Floating flow guide plate
8—Elastic compression element
9—Upper part of the casing
10—Lower part of the casing
12—Individualized cathodic area coated with a catalyst
13—Heat exchanger
14—Photovoltaic cell
15—Optical concentration element
31—Direct coupling device
32—concentrator converter
33—water electrolyser

1-8. (canceled)

9. A direct coupling device to generate hydrogen from concentrated sunlight comprising:
a solar concentrator and a water electrolyser, wherein the solar concentrator comprises an optical concentration element, adjacent to several photovoltaic cells coupled to a heat exchanger, and wherein the water electrolyser comprises a proton exchange membrane in which the membrane has several individualized anode zones and cathodic zones coated with a catalyst, several cathode single-polar plates and several anode single-polar plates arranged adjacent to the catalyst coated areas and, several regeneration electrodes, several floating flow guide plates, several elastic compression elements and a casing consisting of an upper and a lower part.

10. A direct coupling device to generate hydrogen from concentrated sunlight according to claim 9, wherein one of the cathode single-polar plates is in contact with a catalyst coated zone of the proton exchange membrane and one of the anode single-polar plates is in contact with a catalyst coated zone make up an electrochemical cell.

11. A direct coupling device to generate hydrogen from concentrated sunlight according to claim 10, each electrochemical cell being electrically connected in series with a next cell and each cell sharing the same proton membrane, thereby enabling the electrolysis.

12. A direct coupling device to generate hydrogen from concentrated sunlight according to claim 9, wherein a necessary voltage Vd to ensure the electrolysis is supplied by the concentrator converter.

13. A direct coupling device to generate hydrogen from concentrated sunlight according to claim 9, wherein at least one of the anode single-polar plates and cathode single-polar plates has several holes arranged on a main surface and capable of combining a gas diffusion layer and a current collector.

14. A direct coupling device to generate hydrogen from concentrated sunlight according to claim 9, wherein at least one of the floating flow guide plates is compressed by the action of the elastic compression elements against the single-polar plates and, provide an inlet of water and an outlet of water and oxygen, and an output of water and hydrogen.

15. A direct coupling device to generate hydrogen from concentrated sunlight according to claim 9, wherein the regeneration electrodes, under non-operating conditions of the device, ensure removal of contamination in active zones of the water electrolyser by displacing cations accumulated in the proton exchange membrane.

16. A method of hydrogen generation with the direct coupling device claimed in claim 9, comprising:
establishing a water supply circuit for electrolysis, where flow enters the heat exchanger, exiting towards the water inlet at the top of the casing where it is distributed by the floating flow guide plates to bathe anode UPPs, the regeneration electrodes, the catalyst coated zones and the proton exchange membrane;
establishing the hydrogen and water collection circuit, in which a flow of hydrogen and water is led out of the cavity at the bottom of the casing towards a suitable container;
pointing the direct coupling device towards the sun to capture electrical and thermal energy necessary to sustain the electrolysis of the water;
closing the electrical circuit, to polarize the UPPs with operating voltage Vd supplied by the photovoltaic cell to start the electrolysis of the water, which has been heated during its passage through the heat exchanger; and
keep the assembly pointed at the sun as referred to in the third stage, as long as one wishes to maintain the hydrogen generation.
